(19) United States
(12) Patent Application Publication
(10) Pub. No.: US 2021/0270277 A1
(43) Pub. Date: Sep. 2, 2021

(54) Method for Detecting Belt Slippage in a Belt Driven Fan System

(71) Applicant: E&C FinFan, Inc., Ball Ground, GA (US)

(72) Inventors: Jeffrey Scoville, Broken Arrow, OK (US); Michael Lanphier, Owasso, OK (US); Michael Lee, Catoosa, OK (US); David Snell, Glenpool, OK (US)

(21) Appl. No.: 17/185,198

(22) Filed: Feb. 25, 2021

Related U.S. Application Data
(60) Provisional application No. 62/983,990, filed on Mar. 2, 2020.

(51) Int. Cl. F04D 27/00; F04D 25/06; F16H 7/02; F28F 27/00

(52) U.S. Cl. CPC F04D 27/001; F28F 27/00; F16H 7/02; F04D 25/06

(57) ABSTRACT

A belt driven fan system that detects belt slippage includes a fan sheave with a fan sheave marker positioned thereon and a motor sheave with a motor sheave marker positioned thereon. The system also includes a fan sheave sensor, a motor sheave sensor and a drive belt operatively connected between the fan shaft sheave and the motor sheave. A controller is in communication with the fan sheave sensor and the motor sheave sensor.

### CLAIM OF PRIORITY

This application claims the benefit of U.S. Provisional Application No. 62/983,990, filed Mar. 2, 2020, the contents of which are hereby incorporated by reference.

### FIELD OF THE DISCLOSURE

The present disclosure relates generally to detecting belt slippage on drive systems, more particularly, systems and methods for detecting belt slippage on belt driven fan systems utilizing sheave sensors and markers.

### BACKGROUND

Belt driven fan systems are applicable in a variety of industrial settings. They can be utilized in heating and cooling applications. Particularly, belt driven fan systems are utilized in air-cooled heat exchangers. Belt driven fan systems utilize an independent motor that is connected to the fan through a series of sheaves and at least one belt. The inner side of the belt is wrapped around the sheaves.

Tension in the belt of the belt driven fan system should remain relatively constant. When tension decreases, a belt will start slipping. Damage may occur to the fan shaft and fan blades of the belt driven fan system when a belt is slipping. The belt will typically “stick-slip” which means that the fan shaft and fan blades are exposed to large variations in angular speed as the belt disengages and reengages to the sheave, sometimes several times a revolution. Inadequate belt tension will create premature failure of the fan shaft and fan blades due to fatigue.

Current belt driven fan systems may utilize an auto tensioner, which consists of a spring or elastomer loaded arm that keeps tension in the drive system constant (until the limits of the spring/elastomer are reached). The belt tension is checked when the system is offline.

The above-described system does not provide a method for detecting belt slippage “online” with the sheaves and belt operating.

It is desirable to provide a system and method for determining that a belt is slipping, while in operation, allowing the user to re-tension before significant damage occurs.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a belt driven fan system includes a fan sheave, a motor sheave, a fan sheave sensor, a motor sheave sensor, a drive belt and a controller. The fan sheave has a fan sheave marker positioned on a surface of the fan sheave. The motor sheave has a motor sheave marker positioned on a surface of the motor sheave. The drive belt is in contact with the fan sheave and the motor sheave. The controller is in communication with the fan sheave sensor and the motor sheave sensor.

In another aspect, a method of detecting belt slippage in a belt driven fan system includes providing a motor sheave with a motor sheave marker and a fan sheave with a fan sheave marker, providing a motor sheave sensor and a fan sheave sensor, calculating a first RPM ratio of the motor sheave to the fan sheave at a first time, calculating a second RPM ratio of motor sheave to the fan sheave at a second time, and comparing the first RPM ratio to the second RPM ratio to determine whether the belt is slipping.

### BRIEF DESCRIPTION OF THE DRAWINGS

FIG. 1 is a schematic illustration of an embodiment of the belt driven fan system of the current disclosure.

FIG. 2 is a sectional view of the motor sheave portion of an embodiment of the belt driven fan system of the current disclosure.

FIG. 3 is a sectional view of the fan sheave portion of an embodiment of the belt driven fan system of the of the current disclosure.

FIG. 4 is a sectional view of the controller box portion of an embodiment of the belt driven fan system of the current disclosure.

### DETAILED DESCRIPTION OF EMBODIMENTS

An embodiment of the disclosure provides a belt driven fan system for indicating belt slippage while in use and/or online.

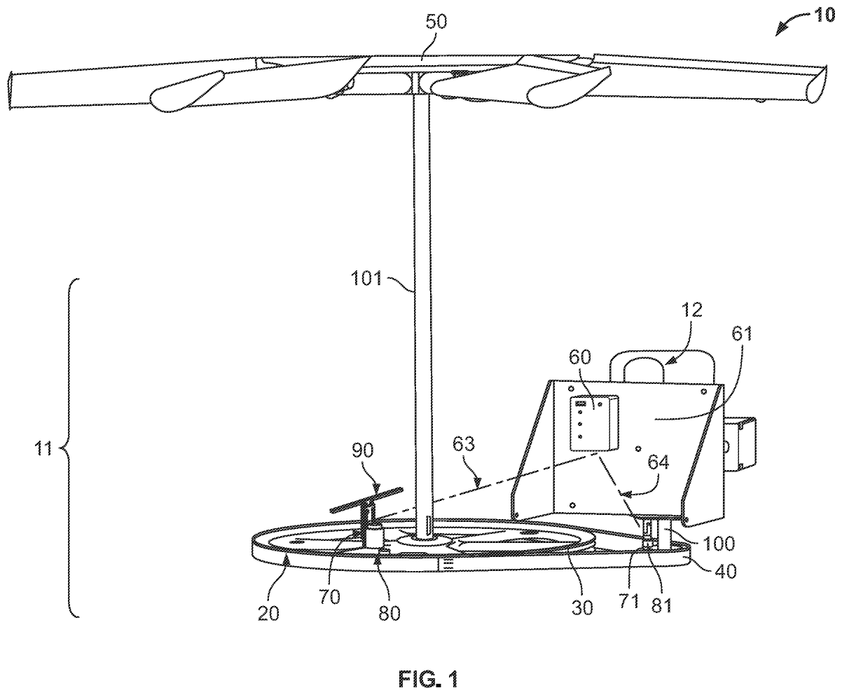

FIG. 1 indicates in general an embodiment of the belt driven fan system 10 of the current disclosure. In the illustrated embodiment, belt driven fan system 10 has a fan 50 powered via a drive system 11 and a motor 12.

The drive system 11 is comprised of a number of parts. Drive system 11 includes a fan sheave 30 and a motor sheave 40 and associated shafts. Fan shaft 101 is connected on one end to fan 50 and on the other end to fan sheave 30. Motor shaft 100 is connected to motor 12 and motor sheave 40. Both sheaves may be grooved wheels for holding a belt or rope. Both sheaves can be made of various metals, for example, iron, steel, and aluminum. The sheaves can also be made of lighter materials, such as plastics. Both fan sheave 30 and motor sheave 40 can be circular in shape. They can be comprised of an inner portion, attached to a shaft, and an outer portion, or rim. As shown in FIG. 1, the fan sheave is larger in diameter than the motor sheave. In alternate systems, the sheaves may be arranged and sized differently. Although FIG. 1 shows two sheaves, the system may include additional functioning sheaves.

Fan sheave and motor sheave are connected by drive belt 20 and are on the inner side of belt 20. The belt 20, extends around the diameters of the fan sheave 30 and motor sheave 40. The belt size is normally adjusted to fit the width of the largest sheave. The belt size is also adjustable to the size and number of sheaves present. The drive belt 20 is comprised of a flexible material and can be made of rubber or other polymers.

Each sheave has an associated marker securely placed on a portion of the surface that is read by an associated sensor, preferably the sheave top or bottom surface. Fan sheave 30 has a fan sheave marker 80. Motor sheave 40 has marker 81 on its surface. As will be discussed further below, the marker composition is based in part on the associated sensor type. The marker may be attached to each sheave by any known conventional means and is also partly based on marker type. For example, the marker or markers may be placed on either sheave by chemical, mechanical or magnetic means. The marker position is such that it is read by the sensor once per revolution of the respective sheave. In one embodiment, the markers are placed on the rims of the sheaves.

Each sheave has an associated sensor. Each sensor is positioned on a device or housing to easily read the associated sheave marker. Fan sheave has sensor 70 which is suspended from an arm or other structure, 90, shown in phantom, that holds the sensor in place. Motor sheave 40 has sensor 71, which is attached to motor 12. The sensor can be any device that can read a marker as it passes and relay the information to a data collecting member. The sensors and markers are configured so that each sensor can read or detect the associated marker when the sheave completes each revolution. Sensors can utilize a wired or wireless source of power, connected to the respective sensor.

The sensors can be any one of a number of proximity sensors. Examples of proximity sensors include ultrasonic sensors, capacitive, photoelectric, inductive, or magnetic sensors. In one embodiment, the sensor can be a magnetic sensor. In a further embodiment the sensor is a hall-effect sensor or reed sensor. Hall-effect sensors, when utilized, can be comprised of conductive material such as silicon or other semi-conductors. A particular embodiment utilizes indium antimonide. When a magnetic sensor, such as the Hall-effect or reed sensor, is used, the associated marker can be a magnet. In a particular embodiment, the magnet is a rare earth magnet. Rare earth magnets can be comprised of different alloys of rare earth elements, such as Neodymium and Samarium Cobalt. When other sensors are utilized, an appropriate marker can be selected. Marker/sensor systems can be magnetic, infrared, or light based or any other technology that allows the microcontroller to determine the time of rotation of the sheave.

Belt driven fan system 10 also includes a housing 61 and controller box 60 containing a controller. The controller can be a microcontroller or any other computer device. Housing 61 may contain various fixtures or elements, including a mounting bracket for the motor associated with motor sheave 40. The controller is in communication, as shown by dotted lines 63 and 64, with fan sheave sensor 70 and motor sheave sensor 71. Controller can be wired or wirelessly connected to each sensor.

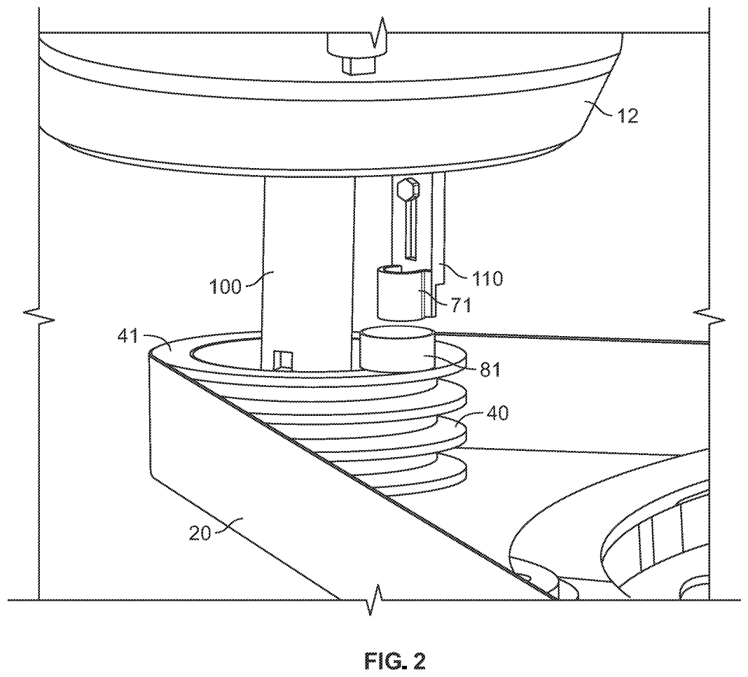

FIG. 2 shows an enlarged view of the motor sheave 40 of the belt driven fan system 10. Motor sheave 30 is attached to motor sheave shaft 100. Motor sheave 40 has motor sheave marker 81 attached to a top surface of the sheave, preferably on rim 41. Motor sensor attachment 110 connects the motor sheave sensor 71 to motor 12. Alternatively, motor sensor attachment 110 can be connected to housing 61 or an arm or other fixture. Motor sensor attachment 110 can be any suitable connector type. As sheave 40 rotates, sensor 71 registers each pass of marker 81 as a revolution.

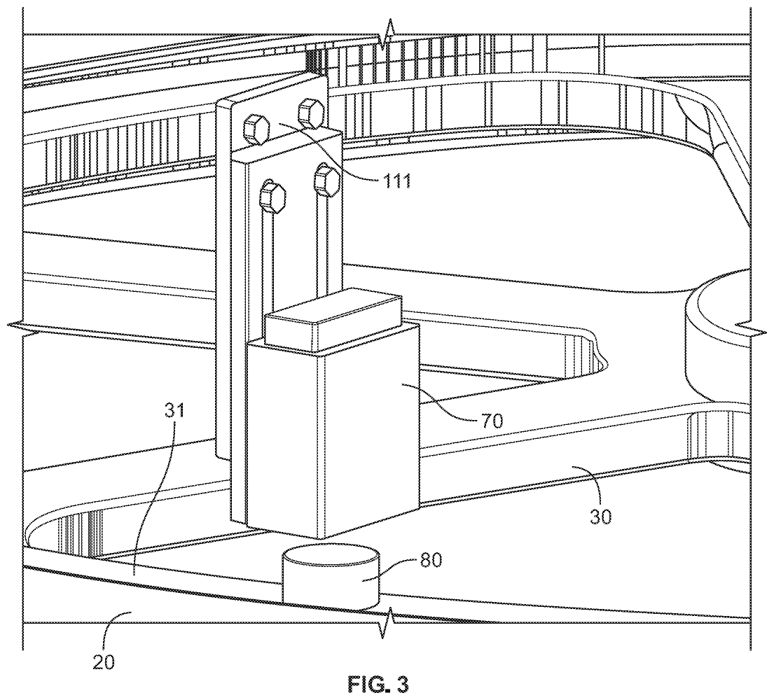

FIG. 3 shows an enlarged view of the fan sheave section of the belt drive fan system 10. As seen more clearly in FIG. 3, fan sheave marker 80 is attached to the rim 31 of the fan sheave 30 on a top surface. Fan sheave sensor 70 is held in place by fan sensor attachment 111. Fan sensor attachment 111 is connected to an arm or other fixture, not shown in FIG. 3 (shown in phantom at 90 in FIG. 1), that holds the attachment and connected sensor in place.

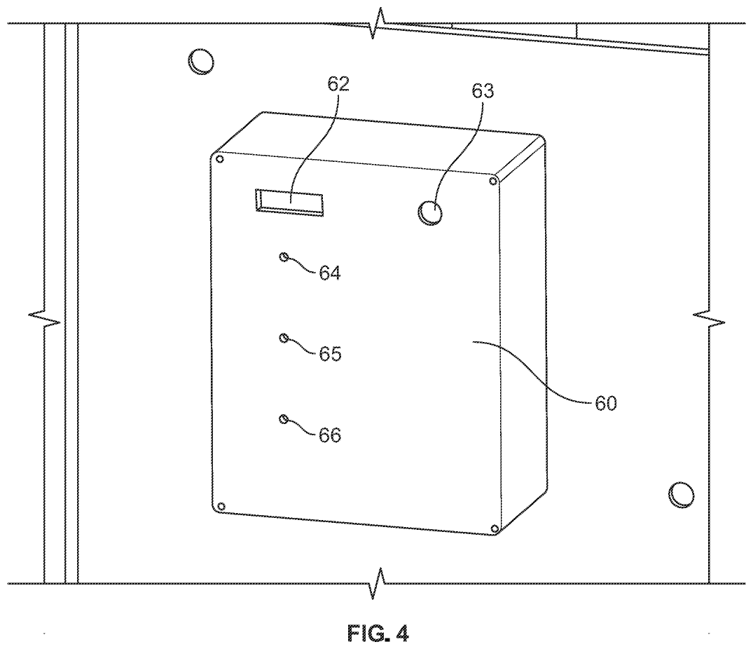

FIG. 4 shows an enlarged view of the controller box 60 which houses a controller. The controller box 60 can be used to relay a variety of information to a user so that they are aware of the current status of the belt driven fan system 10. The controller box 60 can include a memory slot 62 for placing a device used to record information, such as an SD card, USB or thumb drive, or a connector to another computing device. The slot 62 can be used to can store information over time to provide useful data in the event of an issue or as part of a normal maintenance check. Controller box 60 can also include several indicator lights. As shown in FIG. 4, it can include three different indicators, belt slip indicator 64, error indicator 65 and ready indicator 66. Controller 60 can also include a reset button or switch 63.

In order to calculate belt slippage in the belt driven fan system 10 of the current disclosure, both fan sheave sensor 70 and motor sheave sensor 71 detect each passing revolution of their associated marker. Each sensor relays this information to the controller for calculating the number of revolutions per minute for each of the motor sheave and fan sheave. A ratio between the motor sheave and the fan sheave can be calculated. If the belt tension is constant and the belt is not slipping, the ratio between the two sheaves, as calculated, should remain consistent. If and when the belt starts slipping, the ratio of the motor sheave RPM to the fan sheave RPM will increase over time. The controller can be programmed to trigger a visual indication on the controller box when the RPM ratio increases above a certain percentage. For example, a 2-3% increase can be selected to trigger a warning and visual indication. This approach is conservative and will catch a slipping belt much quicker than an audible indication of slipping, which typically occurs around a 30% increase in this ratio. If belt slippage is present, it can quickly be acted on before any significant damage is done.

While the preferred embodiments of the disclosure have been shown and described, it will be apparent to those skilled in the art that changes and modifications may be made therein without departing from the spirit of the disclosure, the scope of which is defined by the following claims.

1. A belt driven fan system for indicating belt slippage, comprising:
a fan sheave with a fan sheave marker positioned on a surface of the fan sheave;
a motor sheave with a motor sheave marker positioned on a surface of the motor
sheave;
a fan sheave sensor;
a motor sheave sensor;
a drive belt operatively connected between the fan shaft sheave and the motor
sheave;
a controller in communication with the fan sheave sensor and the motor sheave
sensor.

2. The belt driven fan system of claim 1, wherein the fan sheave marker is a magnet.

3. The belt driven fan system of claim 1, wherein the motor sheave marker is a magnet.

4. The belt driven fan system of claim 2, wherein the magnet is a rare earth magnet.

5. The belt driven fan system of claim 3, wherein the magnet is a rare earth magnet.

6. The belt driven fan system of claim 1, wherein the fan sheave sensor is a Hall-effect sensor.

7. The belt driven fan system of claim 1, wherein the motor sheave sensor is a Hall-effect sensor.

8. The belt driven fan system of claim 1, further comprising an indicator for indicating that there is a belt slip.

9. The belt driven fan system of claim 1, further comprising a device for logging sheave RPM historical data.

10. The belt driven fan system of claim 1, further comprising a fan shaft connecting the fan sheave to a fan.

11. The belt driven fan system of claim 1, further comprising a motor shaft connecting the motor sheave to the motor.

12. The belt driven fan system of claim 1, wherein the system is a component of an air-cooled heat exchanger.

13. The belt driven fan system of claim 1, wherein the inner side of the drive belt contacts the motor sheave and the fan sheave.

14. A method of detecting belt slippage in a belt driven fan system:
providing a motor sheave with a motor sheave marker and a fan sheave with a fan sheave marker,
providing a motor sheave sensor and a fan sheave sensor;
calculating a first RPM ratio of the motor sheave to the fan sheave at a first time;
calculating a second RPM ratio of motor sheave to the fan sheave a second time;
comparing the first RPM ratio to the second RPM ratio to determine whether the belt is slipping.

15. The method of claim 14, wherein the comparing the first RPM ratio to the second RPM ratio to determine whether the belt is slipping further comprises a percentage increase.

16. The method of claim 15, wherein the percentage increase is at least 2%.

17. The method of claim 16, wherein the percentage increase is less than 2%.

18. The method of claim 16, further comprising determining there is a belt slippage and triggering an indicator light on the controller.

19. The method of claim 16, further comprising determining there is not a belt slippage.

20. The method of claim 14, further comprising logging information onto a device.
